(19) United States
(12) Patent Application Publication
(10) Pub. No.: US 2005/0188066 A1
(43) Pub. Date: Aug. 25, 2005

(54) Arragement and a method relating to end user station access of a portal

(76) Inventors: Thomas Papanikolaou, Aachen (DE); Ake Jarvklo, Tyreso (SE); Ulf Hedlund, Kista (SE)

Correspondence Address: ERICSSON INC., 6300 LEGACY DRIVE, M/S EVR C11, PLANO, TX, 75024, US

(21) Appl. No.: 10/466,605

(22) PCT Filed: Jan. 24, 2002
(86) PCT No.: PCT/SE02/00128

(30) Foreign Application Priority Data
Jan. 24, 2001 (SE) 0100188-2

(51) Int. Cl. G06F 15/173

(52) U.S. Cl. 709/223; 709/217

(57) ABSTRACT

The present invention relates to a portal structure supporting access by end user stations (6) using an access protocol for access requests containing basic information specifying group(s) or class(es) to which a requesting end user station (61) belongs, and type information specifying the type of the requesting end user station. The portal structure comprises a portal core and portal storing means (52) for storing at least type information for at least some type(s) of end user stations. It further comprises a device detection arrangement (53), and the portal storing means (52) supports storing of basic information such as class belongings of end user stations. If the type of an end user station (6) requesting access is not recognized by the portal structure, and if it is established that a class/group to which the end user station belongs is known by the portal, the device detecting arrangement (53) requests, using the class/group information relating to the end user station, type information from the end user station which, when retrieved, is stored into the portal storing means (52), such that the end user station (6) is able to access the portal structure.

### TECHNICAL FIELD

The present invention relates to providing end user stations with access to a portal structure. The invention also relates to an arrangement in a portal structure for handling end user station access to the portal structure, and to a method of providing end user stations with access to a portal. Particularly the invention relates to detection of the type of an end user station requesting access to a portal structure, when the portal structure is able to support access by different types of end user stations, such that access to the portal can be allowed to the end user station.

### STATE OF THE ART

When referring to a portal, generally an Internet portal is meant. Today much effort is spent on personalization and customization of the ways an end user should be provided with access to services, irrespectively of the actual location of the services or applications. At the same time the demand for access to mobile Internet services gains importance, i.e. the end users need to be able to, in a rapid and uncomplicated manner, get access to services from any end user station, i.e. also from mobile devices; it may e.g. relate to sending and receiving e-mails, short messages, accessing WEB-based information from mobile as well as fixed end user devices in a user friendly, quick and simple manner. This is called the mobile Internet.

Browsing using the mobile device is however more difficult than browsing using a PC since the mobile device, as compared to the PC, has limited input and output capabilities; thus, this means that it gets even more difficult to provide mobile end users with a satisfactory personalization and management of access to services. Thus there is an increasing demand on behalf of the end user to always be able to access applications and services. A portal is such a doorway to the content of services and applications which particularly should be tailored to suit the end user preferences.

Examples of portal content are information services (also including push content which relates to an Internet technique through which all information a user subscribes to automatically is provided to the user, or information that the service provider or operator means that the user should be provided with). Examples on information services are weather forecasts or weather information in general, commercial services such as shopping malls, or generally any kind of information, multimedia services such as streaming audio/video, games, instant messaging and newsgroups, WEB-based mail, access to particular communities through chat-rooms. It is highly desirable to be able to provide appealing graphical user interfaces for representing applications and menus on PC:s, and particularly also for WAP-enabled devices, in case a portal is mobile. Much effort is also spent on personalizing the structure and the content of personal portals, and to provide a possibility to control the interaction and behaviour of individual services and applications by setting personal preferences. It has however turned out to be difficult to provide for satisfactory access possibilities, as well as satisfactory navigation properties, irrespectively of which kind of device that is used by an end user.

A portal core is the central part of the portal structure, that is needed to develop a portal framework, within which content and applications can be disclosed and accessed by end users in a controlled and unified manner.

Until now many applications are in principle exclusively designed for the 2G telecommunications environment, and they have been implemented as monolithical blocks, or with a proprietary service network to handle the specific Qos requirements for the respective applications. This has a consequence that such applications work satisfactorily as isolated applications, but they are difficult to integrate with other applications developed in similar ways. Applications developed for the Internet (Internet protocol) environment have to a large extent been based on established and open de facto standards supporting extensive integration of different applications. Many such standards have been used in the 2G environment for non real-time critical applications. However, through the introduction of 3G networks (3GPP) future applications will contain a mixture of telecommunication and datacommunication services mixing higher and lower bit rates as well as real time and non-real time traffic. The service networks of today are not designed to handle such mixtures, nor are the existing IP-based applications designed for the specific characteristica of wireless networks. As can be seen there are many factors complicating the provisioning of satisfactory access for end users to services/applications.

By using a generic markup language in a portal, content of applications and services can be stored independently of end user station or user device and, before showing the content of an application or a service, the content can be transformed to a format, i.e. the markup language, that can be understood by the end user device. One example on such a generic markup language is the XML (Extended Markup Language). Thus, by using a generic markup language different kinds of end user stations can be provided with access to the portal. XML is described in Extensible Markup Language (XML) 1.0 (Second Edition) which is a W3C Recommendation of 6 Oct. 2000, which herewith is incorporated herein by reference.

Internet portals usually provide a device detection mechanism, for detecting which kind or type of end user station an end user uses, so that the user accessing the portal can be directed to the appropriate content pages, e.g. the appropriate markup language used by the end user station. A mobile end user station, such as a WAP-device (Wireless Application Protocol), uses for instance WML (Wireless Markup Language), whereas for a fixed end user station HTML (Hyper Text Markup Language), may be used. Likewise, such device independent portals based on a generic markup language, such as XML, require device information, i.e. end user station information, in order to be able to dynamically generate content for the end user station. If the end user station can not be properly detected, then the user usually will be confronted with a system error, which is a bad experience and which may cause user fluctuation. Device detection methods for HTTP (Hyper Text Transfer Protocol), which is the access protocol used by an end user station accessing a portal, are specified in various specifications such as for example the Serylet Session API. The detection methods are generally based on using device databases. Such methods utilize the information transferred with the HTTP message header to detect the underlying device as:
1. Get the User-Agent stored in the HTTP Header.
2. Try to retrieve (using a database) device information using the User-Agent as a key.
3. In case of failure, try to read the accepted MIME types.
4. Try to retrieve (using a database) further device information.
5. In case of failure, abort.

When a user accesses an Internet Portal using HTTP, the portal is able to retrieve, using the information stored in the HTTP header, various details about the user's device, e.g. the user agent, which is a unique identifier of the device or, of the browser the user's device is using.

The portal (presentation) engine can use this information to present content adapted to the user's device. For example, when a user accesses the portal using a WAP phone, the portal will reply using WML. If the user access the portal using an HTML browser, the portal will reply using HTML.

As long as the device of the user can be properly detected, the portal can react appropriately. However, if the device cannot be detected, i.e. is not recognized, the portal may not be able to reply in the appropriate language, or, even worse, produce a system error on the user's device by replying in the wrong language.

WO 00/65773 shows a portal which is (exclusively) WEB-based. The portal can be accessed by one single type of stationary devices (WEB-browsers) only, which do understand a structured HTML markup language. It is a serious drawback that only one specific type of devices can be accessed. The document does not disclose any reliable device detection.

### SUMMARY OF THE INVENTION

What is needed is therefore a portal structure that is able to, in a reliable way, provide end user stations of different types or kinds with access to the portal. Particularly a portal structure is needed which enables detection of end user stations such that access can be allowed also to end user stations not specifically known by the portal. Particularly a reliable device detection is needed in a portal structure which is mobile and for which the HTTP access protocol is used (Hyper Text Transfer Protocol).

Moreover a portal structure is needed which provides for a generic detection of end user stations in a mobile portal structure, or particularly a portal structure using a generic markup language, most particularly XML.

Further yet a portal structure is needed which does not require the provisioning of information relating to all specific end user station types that should be given access, before activated or put into operation. Particularly a portal structure is needed which does not need to keep information about every specific end user station type that should be allowed access to the portal. Still further a portal structure is needed, which is capable of providing for an uncomplicated and fast access to end user stations of different types.

An arrangement, in a portal structure, for end user station detection is also needed through which one or more of the above mentioned objects can be achieved. Still further a method of providing end user stations, of a number of different types, with access to a portal structure, in a reliable way, is needed, through which one or more of the above mentioned objects can be fulfilled.

In the following, before giving the specifics of the present invention, some concepts used in this document will be described or defined. A portal is generally a non-physical entity in the Internet domain which can be described as an “electronic publishing space”, which is owned by an individual or an organization, and which provides either direct access to information and services, or links to other entities in the Internet or private intranet domains, providing information and services, to authorized end users. A portal is in its simplest form a regular home page or list of links whereas, in more advanced forms, it may offer interactive services, not only to those who consume what is published, but also to those who are granted the right by the editor to publish on the portal, as well as to the editor himself, regarding different aspects on how the portal is used.

Wireless end users are given access through a “service” portal. Such a service portal is different from a traditional fixed Internet portal for PCs and end users demand personalized services delivered to, and presented on, their mobile terminal at least as an option. However, in this document a portal structure is taken to mean both a “common” portal and a “service” portal.

An application is one or several cooperating software entities, the functional focus being user interaction and usefulness for the end user. An application platform is a defined combination of software and hardware entities used to implement applications of a certain kind, which are characterized by the functionality and quality of its constituent parts.

By portal infrastructure is, in general terms, meant the software and hardware entities needed to either host or produce or generate a specific portal. Specifically it contains a portal core, an IP infrastructure and service enablers.

A service enabler is a support functionality accessed via APIs (Application Programming Interface) raising the abstraction level and simplifying the application developer's task. A portal core is the core of a portal infrastructure. By a service network is generally meant an IP-based network which consists of nodes hosting application servers, service capability servers, application support servers, IP infrastructure servers etc. Application support servers interface with service network resources or other external resources than core networks, whereas service capability servers interface with resources and functionality in core networks.

In the present application a portal structure is intended to mean a portal core, a plurality of services and applications with their content, and service enabling means (service enablers). Generally may also the connectivity and data bearer functionality be seen as included.

To solve the problems referred to above, the present invention provides a portal structure supporting access by end user stations, using an access protocol for access requests. The access requests contain information about the end user stations. The information comprises basic information specifying group or class belongings) of the requesting end user station and type information specifying the type of the requesting end user station. The portal structure comprises a portal core with portal session managing means, request handling means (request broker) and portal storing means for storing at least type information for at least some types of end user stations. It further comprises a device detection arrangement. The portal storing means supports storing of basic information such as groups or classes. If the type of a requesting end user station is not recognized by the portal structure, then it is established if the class(es)/group(s) is/are known by the portal. If yes, the detecting arrangement uses the class/group information relating to the end user station, to request type information from the end user station. This type information, when retrieved, is stored into the portal storing means, and the end user station is given access to the portal. The access protocol is particularly HTTP. The portal structure is in an advantageous implementation based on a generic markup language, supporting access by end user stations independently of type/class of the end user station. The generic markup language is even more particularly XML.

The portal structure comprises rendering means for translating service/application data, from an accessed service/application using a generic markup language, into the markup language used by the accessing end user station. The class/group information particularly comprises information relating to the markup language used by the requesting end user station, or particularly information relating to markup languages understandable to the end user station. The portal structure is preferably mobile, which means that it supports access by mobile as well as fixed end user stations, such as for example WAP-devices using WML and PCs using HTML. The type information particularly comprises a so called user agent uniquely identifying the end user station, or more particularly the browser used by the end user station.

An end user station is particularly an entity accessing the portal. To each end user station there is device information associated. Each end user station or device belongs to a class (at least one), using a particular markup language, such as for example WML, HTML, and it also comprises a user agent, for example Ericsson R380/WAP1.1 which specifies the device more precisely.

In a preferred implementation the portal storing means comprises a terminal database. If the type indication, the user agent, in an end user request message is recognized or found in the portal storing means, the corresponding type information is fetched by the request broker for storing into an end user portal session, which will be created by the portal session managing means as soon as access is allowed.

If the type indication (user agent) in an end user request message is not recognized or found in the portal storing means, the request broker establishes if the class, as indicated by the request message, is available in the portal storing means. This means that it is examined if the class or group, or if any of the classes/groups, (if the end user station supports more than one class or group) is supported by the portal structure. If this is the case, it passes on information about the class/group to the device detecting arrangement. The device detecting arrangement then presents a configuration page to the end user station, requesting an end user type information input from the end user station. When the requested end user station type information has been received in the device detection arrangement, it is stored into the storing portal storing means.

This will have as a consequence that, the subsequent time an end user station of the same type requests access to the portal, the type will actually be found in the storing means, and access can be given without having to request for further information from the end user station. Thus, the portal has been generally updated with a new type of end user station. This means that the portal structure is adaptive or self-learning in that it will recognize more and more types of devices.

The class information particularly comprises information about the markup language used by the end user station. This allows the device detection arrangement to communicate with the end user station, which explains why the device detection arrangement is able to communicate, and request further information from the, hitherto unknown, end user station type.

The invention also provides for an arrangement for end user station detection or recognition, in a portal structure comprising portal session managing means, portal storing means and request handling means. The arrangement comprises an end user station (device) detection arrangement for detecting if class (group) information relating to the end user station class belongings, such as the markup language used by the end user station, is contained in the portal structure, and if yes, using the markup language of the end user station for requesting and fetching further information relating to the end user station type from the end user station, and for storing such type information into the portal storing means. The arrangement particularly uses information about end user station class (group) belonging included in the end user station request, as supported by the access protocol, which particularly is the HTTP, in which case such information is contained in the HTTP header. The inventive concept is of course not limited to the HTTP protocol, but any protocol containing information about class or group belonging of an end user station, including the used markup language, and more specified type information, can be used.

The portal structure preferably uses a generic markup language, such as XML, and access by mobile as well as fixed end user stations is supported.

The invention also provides for a method of providing an end user station with access to a portal structure by detecting characteristics, e.g. type, of an end user station requesting access. The method comprises the steps of; receiving an end user station request in the portal structure which request contains information relating to type of end user station and basic information relating to class/group belonging(s) of the end user station; examining if there is any information about the type of the end user station in the portal, whereas if yes, allowing the end user station to access the portal, otherwise; examining if there is any information about the class(es)/group(s) to which the end user station belongs, i.e. if the portal supports (any of) the class(es)/group(s) to which the end user station belongs; if yes, using the recognized class/group information to retrieve further information relating to the type of the end user station from the end user station; storing the retrieved type information in the portal storing means; allowing the end user station to access the portal.

Preferably the HTTP protocol is used for the end user station access request, and the portal particularly uses a generic markup language, e.g. XML, and supports access by mobile as well as fixed end user stations e.g. using WML or HTML respectively as markup language. The class information particularly comprises information relating to the markup language(s) used/supported by the end user station.

The step of examining if the type of requesting end user station is known by the portal comprises the steps of; examining if the type is stored in the portal storing means, e.g. a terminal database, and, the steps of examining if any of the class(es)/group(s) is/are known by the portal comprises; examining if the class/group is stored in the portal storing means, e.g. a terminal database.

The step of retrieving further information from the end user station particularly comprises; fetching the class/group, comprising markup language information, from the portal storing means to an end user station (device) detecting arrangement; using the markup language in the detecting arrangement according to the class/group information to present a configuration page to the end user station; receiving requested configuration data from the end user station in the device detecting arrangement; storing the received configuration data into the portal storing means; allowing the end user station to access the portal.

It is an advantage of the invention that a generic, fault-tolerant device detection mechanism is provided, particularly for portals using a generic markup language such as XML. When an end user station can not be detected, i.e. when it is not recognized by a portal, the device class, or one of the device classes, i.e. end user station class, can be used to allow a portal to obtain further information about the end user station, by presenting a configuration page to the user. Implementing such a device detection arrangement or application as such is easy, and it removes the necessity of having to populate a portal storing means, particularly a terminal database, with all available terminals, or end user stations, before a portal is put into operation. Still further it gets possible to provide access to end user stations which are not known by the portal structure and to future end user stations, as long as the used access protocols support the provisioning of class information and on condition that said class information is stored in storing means in, or associated with, a portal structure.

### BRIEF DESCRIPTION OF THE DRAWINGS

The invention will in the following be further described in a non-limiting manner and with reference to the accompanying drawings in which:

FIG. 1 schematically illustrates an overview of a portal structure to which the inventive concept can be implemented,

FIG. 2 illustrates a conceptual division of a presentation arrangement (layer) into a rendering functioning layer and a service functioning layer,

FIG. 3 is a block diagram describing the portal core to which an end user station requests access with a device detection arrangement according to the invention,

FIG. 4 is a flow diagram describing the inventive procedure when an end user station accesses a portal structure, and

FIG. 5 is a diagram illustrating the interactions within the portal core when an end user station of a type not recognized by the portal requests access.

### DETAILED DESCRIPTION OF THE INVENTION

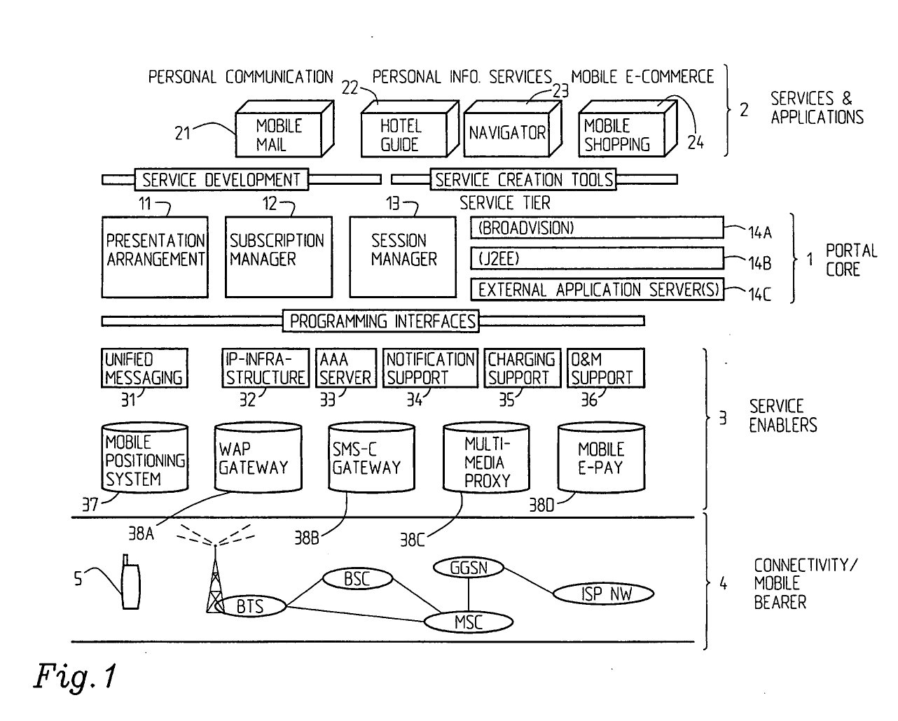

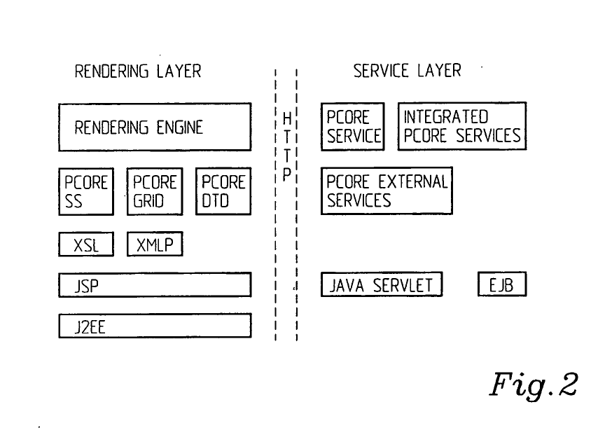

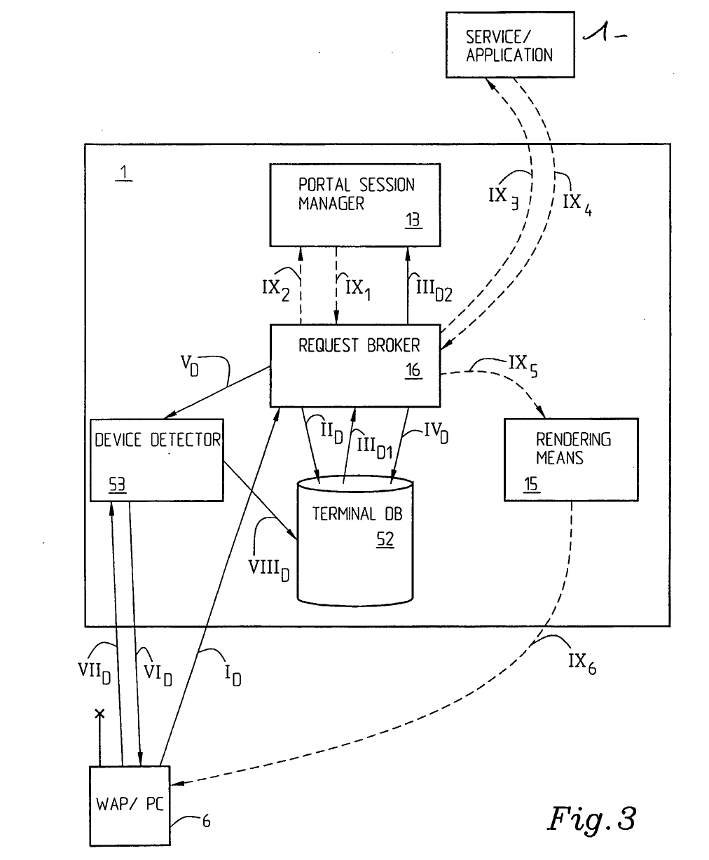

With reference to FIGS. 1 and 2 an exemplary portal structure will be described in a quite detailed manner. Such a portal structure may be used in the implementation of the inventive concept which is described with reference to FIGS. 3-5. It should, however, also be clear that the invention by no means is limited to be implemented in a portal as described in FIGS. 1 and 2, this portion of the description mainly being included for describing some exemplifying underlying concepts and the functioning of an exemplary portal structure as such.

FIG. 1 thus shows one example on a portal structure 10. It comprises a portal core 1 handling presentation functionalities, subscription and session management functionalities, a number of services and applications 2, comprising for example personal communication services, personal information services and Mobile E-Commerce services. In brief, it is, for the functioning of the present invention, not important which types of services that are provided, since the invention is concerned with providing end user stations with access to the portal structure, which is a precondition for being able for provide an end user station with access to a service/application via the portal structure.

The portal structure 1 further includes a layer 3 including a number of service enabling means (service enablers) 31-37, 38A-38D. The service enablers are among other things involved in authentication and basic services such as gateways and IP infrastructure. In this figure some examples on service enablers are given, such as unified messaging 31, IP infrastructure 32, AAA-Server 33, notification support 34, charging support 35 and operation and maintenance support 36. Further service enablers here relate to a mobile positioning system 37, a WAP gateway 38A, SMS-C gateway 38B, a multimedia proxy 38C, mobile E-pay 38D etc. It should be clear that some of these service enablers are mandatory whereas others are optional.

The portal structure is here also seen as including a connectivity or a (mobile) bearer layer comprising the mobile base stations and switching nodes, such as BTS (Base Transceiver Station), BSC (Base Station Controller), MSC (Mobile Switching Center) nodes etc. Which the nodes are, depends on which mobile network access is provided over, e.g. GSM. For GPRS or UMTS corresponding nodes are included in this layer; for example GGSN (Gateway GPRS Support Node). Whichever is the network, the network is the data bearer for the portal for access of mobile devices such as e.g. WAP-devices (Wireless Application Protocol). In FIG. 1 it is supposed that the accessing end user station comprises a WAP-telephone 5.

One example on such a portal structure is the Ericsson WISE™ Portal.

It is here advantageously supposed that the portal supports access by mobile end user stations, such as WAP-telephones 5 over a mobile network. Therefore nodes or components of the relevant mobile network have to be provided in a mobile network connectivity and data bearer layer. In FIG. 1 a component denoted ISP network, Internet Service Provider network is disclosed. This is an optional component which may be included or not.

Some of the service enablers are important components for providing mobile Internet functionalities and some of them can be seen as one part of the interface components between Internet and the mobile network. One component is here denoted IP infrastructure 32. An optional service enabler comprises the notification support 34, which generally is an optional component enabling applications to send out filtered notifications to end users using the SMS (Short Message Service) channel, but it may also be adapted to include other channels supporting WAP technology and 3G (3GPP) technology. Charging support enabler 35 may be provided to allow for flexibly choosing charging events. Another service enabler 36 relates to operation and maintenance support and generally it is a mandatory component. A service enabler WAP gateway 38A relates to an optional service enabler WAP gateway/proxy forming the access point between the wireless world and the Internet world. It supports mobile clients accessing the WAP gateway/proxy using GSM circuit switched data or WAP over SMS (SMS over MAP (Mobile Application Protocol)). The client uses a WAP enabled browser in the mobile device to connect to the WEB-server where the desired WAP application resides. The mobile positioning system 37 is an optional component allowing sending the position of a user to the application requesting it. The optional service enabler multimedia proxy 38C is responsible for transmitting multimedia data over GPRS or UMTS. SMS-C (centre) gateway 38B is an optional component which is responsible for sending or receiving, storing and forwarding short messages between mobile stations and servers. Proprietary protocols are used for communication with applications. Mobile E-pay 38D is a component offering the basic functionality for Mobile E-Commerce and it is optional. AAA-Server 33 is a service enabling component relating to authentication, authorization and accounting. These functionalities may be provided in other manners, but they may also be integrated in a functionality server for example enabling traffic based charging and period charging. Such a component, either if it is split up into different components, or if it comprises a single component which is common for a number of functionalities, is mandatory, and in an advantageous implementation it is used for session management functionalities.

However, it should be clear that FIG. 1 merely shows examples on service enabling means that may be provided in a service enabling layer 3.

The portal core handles, as referred to above, presentation, subscription and session management and service tiers comprising a number of internal (and external) application servers. The core 1 comprises a presentation arrangement 11 (also called presentation engine or portal engine), which enables mobile, portal presentation on multiple devices using multiple protocols. It may e.g. be XML driven (or more generally driven by a generic markup language). In one implementation it is a Java™ and XML driven multimarkup language capable presentation module.

The presentation arrangement 11 comprises rendering means which in one implementation uses XML/XSLT technologies to ensure that information presented by services within the portal is displayed in a standardized way regardless of which end user station an end user uses, when accessing the portal structure. Through the use of a generic markup language, for example XML/XSLT, the “look and feel” of content presented to end users may be customized. The Swedish patent application “An arrangement and a method for presentation customization in a portal structure” which is an application filed on the same date and by the same applicant as the present application and the content of which herewith is incorporated herein by reference, relates to user customization in a portal structure as described herein, and particularly it is concerned with “look and feel” customization. XSL is described in XSL Transformations (XSLT) Version 1.0, W3C Recommendation 16 Nov. 1999, and XSL Transformations (XSLT) Version 1.1, W3C Working draft, 12 Dec. 2000, which documents herewith are incorporated herein by reference.

The functionalities within the portal core 1 in general, and of the presentation arrangement 11 in particular, will be further described with reference to FIG. 2.

The portal core 1 also includes the subscription manager. In one implementation subscription manager component information is stored in an LDAP (Lightweight Directory Access Protocol) directory and it is managed by a service called subscription manager. The subscription manager includes functions for the operator to create, maintain and delete subscriber information in the subscriber (terminal) database. It also enables the end user of the system to register with the services in the system. In a particular implementation a self-registration and self-service concept is supported in order to minimize costs by minimizing the workload on a customer care center. Information about available services may also be kept in the directory referred to above and handled by the subscription manager. As a new service is entered to the directory, it will immediately be available for subscription by the end users. In the directory end users can be grouped so as to make new services available only to defined sets of end users. The subscription manager 12 can be interfaced with an existing customer care system through the application programming interface (API) it uses.

The session manager 13 is a general mechanism that can be used by applications and services. It comprises an interface to a subsystem for keeping track of all visitors to the portal and to provide the profile information of the visitors. When an end user enters the portal for accessing an application/a service, a session-id entity is allocated which is stored for that particular end user until logging out of the service, or when the end user has been idle for a preset period of time. When a participating application starts to run, it first checks if there is an active session-id for a particular user, and if there is, it would be able to resume from where the session was broken. Session management functionalities are e.g. described in “An Arrangement and a Method Relating to Session Management in a Portal Structure” which is a Swedish patent application filed on the same date and by the same applicant as the present application, the content of which herewith is incorporated herein by reference.

Finally the portal core structure 1 here comprises two “internal” application servers 14A, 14B and one or more external application server 14C. The external application server 14C contains links to external application servers running existing services. In one implementation the service tier comprises three classes of services, of which a first is developed in compliance with the portal core specifications implemented using the portal core environment. A second service class relates to services which not necessarily are implemented in the portal core environment, such as for example an external e-mail system running on a non-portal core environment adapted to present itself through the portal core presentation. The third service class relates to external services which do not comply with the portal core service development or presentation architectures. In the following the portal core, and specifically the presentation arrangement, comprised in the presentation layer, will be more thoroughly described, still with reference to FIG. 2.

The service tier, in one advantageous implementation, comprises three service classes. The service class portal core service (pcoreservice) complies with the specifications of the portal core and it is used to leverage the portal core characteristics. In one implementation the services are implemented using the J2EE IBM WEBSphere Environment (an application server used to develop programmatic services involving logic, algorithms etc.). Such services generally have three or four tier architectures deploying JSP (Java Server Pages) on the front end, Java serylets and Enterprise Java Beans (EJB) in the middle layer, and various entities on the back end. The second service class are the integrated portal core services (integrated pcore services) which leverage pcore presentation services but which are not necessarily implemented in the portal core J2EE environment, e.g. an external e-mail system running on a non-portal core environment but adapted to present itself through the portal core presentation. The third service class, pcore external services, neither complies with the portal core service development, nor with the presentation architectures, but services of the third service class, i.e. the pcore external services may e.g. be triggered to or brokered by the portal core.

In one implementation there are two types of service options available within the service layer. One may consist of services provided by Broadvision (CORBA™; for creating optimized rule based and personalized services connected to commerce and retail), and optimized for content delivery by a matching engine operating on content, profile and business rules. The other service type relates to programmatic services for example requiring algorithms, logic etc. which are not easily built in an optimized content delivery system. If these services are of pcore service class, then they may be industrialized for IBM WEBSphere J2EE environment and if they are of integrated services class and running in an external service server, they are adapted to the portal core presentation.

A service needs specifications including elements on the rendering functionality of the presentation layer as well as relating to the service layer functionality, i.e. schemes and logic. The portal core presentation architecture may, as referred to above, in one advantageous embodiment implement the J2EE architecture for the mechanisms of creating and employing services in specific elements or for defining services. However, the invention is not limited to a portal structure using J2EE and Broadvision which merely are given as examples.

The presentation layer is conceptually split-up into two tiers, one rendering layer residing in the portal core itself and a service layer available to any service that wants to presents its content through the portal core presentation structure. The rendering layer in one advantageous implementation uses XML/XSLT technologies. Thereby it is also ensured that information presented by services within the portal can be displayed in a standardized way irrespectively of which is the end user station, i.e. irrespectively of which kind of end user station the end user uses when accessing the portal.

If XML is used as a generic markup language, a service produces an output in the form of an XML document formatted using structure information from a pcore DTD. The XML output from the service is then used to feed the presentation engine of the presentation arrangement. The presentation engine uses pcore SS and pcore grid information associated with the pcore DTD of the XML document supplied by the service to generate the desired interface. Services which do not produce XML from a pcore DTD are particularly also able to present themselves through the presentation services.

As referred to earlier, the portal structure is advantageously able to handle different devices such as WAP-phones and broadband devices such as PCs. By a device is actually meant the browser used by the device. Generally it is the same as the device for a WAP-phone, but a PC may use different browsers. A portal core structure platform and the logic in it are particularly totally separated from the presentation layer functionality, which makes it very easy to implement support for all different types of clients, even voice and speech synthesizers. By using for example XML/XSL, it is very easy to implement support for instance for a new type of WAP-display size. It is also possible to adapt the rendering process to various WEB-devices, existing and future hand-held devices, voice browsing and interactive TV.

Above one example of a portal structure has been described to which the inventive concept can be implemented. However, the invention as such is of course not limited to be implemented in such a portal but it assumes that a portal structure is established which is able to provide end users, i.e. (end user stations) or entities accessing the portal, of different kinds, with access. For each end user a session is created by the portal and each session contains end user specific data. A service/application may be external or internal. In this context an internal application or a service is defined as an application or a service using the session management of the portal, whereas an external application service is taken to mean an application or a service using an external session management, which means that it may provide for the session management itself, or it may be session-managed by a third party.

However, to access a service/application, access must first be provided to the portal structure itself. The inventive concept will now be described more in detail with reference to FIGS. 3-5. To handle access requests by different kinds of end user stations (devices), FIG. 3 shows a portal core 1 with a device detecting arrangement, the device detector 53, for implementation of the inventive concept, when an end user station 6 requests access to the portal. When end user station 6, which for example may be a WAP-device or a PC using a browser, wants to access the portal, it sends an access request, which is received in the portal core request broker 16. It is supposed that an access protocol is used, supporting the inclusion of basic information relating to class or group belonging(s) of the end user station, as well as information about the type of the end user station, i.e. more specific information. Upon reception of the request, ID, in the request broker 16, it calls the terminal database 52 using an indication of the type to find out if the type is recognized by the terminal database 52, II_{D}. If the access protocol that is used is HTTP, the call may comprise a request to get the user agent, and if the user agent is recognized by the terminal database, i.e. contained in the terminal database, this means that the type information relating to the end user station is contained in the terminal database. Thus, if recognized, the type information is retrieved from the terminal database 52 by the request broker 16, III_{D1}, which then forwards the information to the portal session manager 13, III_{D2}, which provides for creation and storing of an end user portal session.

However, if the type indication information, or the user agent, is not recognized by the terminal database 52, this is established by the request broker 16, which then calls the terminal database to find out as if the class or group belonging is known by the terminal database, i.e. if any of the classes (or the class) supported by the end user station, is contained in the terminal database, IV_{D}. If yes, the class information is retrieved by the request broker 16, which forwards the class information to the device detecting arrangement 53, V_{D}. Since the class information, according to the invention, comprises information about the markup language used by, or understandable to, the end user station 6, it is possible for the device detecting arrangement 53 to communicate with the end user station 6.

The device detecting arrangement 53 then requests further information relating to the type of the end user station from the end user station, VI_{D}. This may for example be done by presenting a configuration page to the end user station. The end user then enters the requested data into the end user station and the requested data is subsequently returned to the device detecting arrangement, VII_{D}. The device detecting arrangement 53 then forwards the type data, or more generally the end user station type data, to the terminal database 52, VIII_{D}, where the type data is stored, such that it can be found, if the same, or if another end user station of the same type, wants to access the portal. This means that the portal is adaptively updated to contain information about, such that it will be able to recognize, more and more types of end user stations. Thus it does not have to be provided with type information about every end user station available on the market right from the beginning, but it is adaptable, as long as it contains the more general basic information relating to the end user stations. Thus, it is now possible for the end user to enter the portal which is illustrated through the dashed arrows in the figure. This means that a portal session is created, IX₁, IX₂, the request is forwarded, IX₃, to the service application as requested by the end user station, which particularly generates XML data, or more generally data in a generic markup language, which data then is returned, IX₄, to the portal request broker for rendering into the markup language, which is used by the end user station, IX₅. Subsequently the data is sent to the end user station 6, IX₆, in the appropriate language.

The concept of unified session management as disclosed in the patent application “An Arrangement and a Method Relating to Session Management in a Portal Structure” which was incorporated herein by reference, may be implemented. Further, in order to provide for continuous navigation within the portal irrespectively of whether accessed services or applications are external or internal, the concept of introducing metalinks into the service or application data in a generic markup language can be implemented as disclosed in the copending patent application “An Arrangement and a Method Relating to Access of Applications/Services” which was filed on the same date and by the same applicant as the present application and the content of which herewith is incorporated herein by reference.

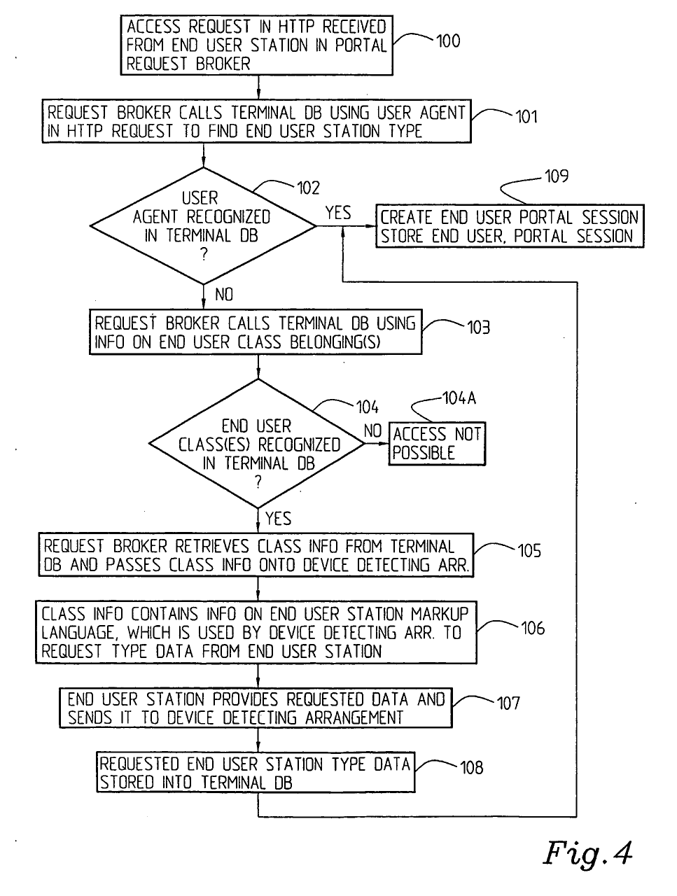

The procedure according to one embodiment of the present invention will now be explained with reference to the flow diagram of FIG. 4. When an access request, e.g. in the HTTP protocol, is received from an end user station in the portal request broker, 100, the request broker calls the terminal database, using the user agent in the HTTP request, to find the user agent in the terminal database, i.e. the end user station type, 101.

If the user agent is recognized in the terminal data base, i.e. if it is stored in the terminal database, 102, an end user portal session is created and stored by the session manager, 109, in a conventional manner.

However, if the user agent is not recognized or contained in the terminal database, 102, this is detected by the request broker, which then calls the terminal database using information about the end user class belonging(s) to retrieve the device class(es) supported by the end user station, 103. If none of the end user class(es) (or the class) is recognized, i.e. contained in the terminal database, 104, access is not possible, 104A. If on the other hand an end user class is recognized, i.e. it is contained in the terminal database, the request broker retrieves the corresponding class information from the terminal database and passes it on to the device detecting arrangement, 105.

Since the class information contains information about which markup language the end user station uses or understands, this language is used by the device detecting arrangement to request type data, i.e. further, specific, information from the end user station, 106. One way to do this is to present a configuration page to the end user station. The end user station then provides the requested data, i.e. through configuration of the end user station by the end user, and the requested data is sent to the device detecting arrangement, 107. The device detecting arrangement then provides the requested end user station type data to the terminal database for storing therein, 108. Subsequently, cf. step 109 above, an end user portal session is created and stored by the session managing means in a conventional manner. Thus an end user station of an unknown type (not recognized by the portal) has been provided with access to the portal, and, access is enabled to other end user stations of the same type as well, but then without the need of user interaction. The portal has been adaptively, or generically, upgraded.

The device detecting arrangement particularly is an active component running within the portal core. The first time the end user station accesses the portal structure, if not recognized, the device detecting arrangement is called to retrieve further information about the end user station.

Below a specific implementation will be given in a detailed manner. In order for the device detecting arrangement to be functional, in this case, the following operations must be available in the portal:
A. UserAgent agent=httpRequest.getAgent( )
B. DeviceClasses dcs=httpRequest.getDeviceClasses( )
C. Boolean b=terminalDatabase.supportsDeviceClass(DeviceClass dc)

Operations A, B can be implemented using the HTTP protocol information, or the corresponding information if another protocol is used. Operation C can be implemented using Operation B and a(any) database.

When an end user accesses the portal via HTTP, in a particular implementation, the following actions are taken:
1. The function httpRequest.getAgent( ) is called to retrieve the user agent.
2. The user agent is used as a key to a terminal database. If the user agent is found, the device information is returned. Otherwise:
3. The function httpRequest.getDeviceClasses( ) is called to retrieve the device classes supported by the end user station (the device).
4. If one of the device classes is known in the terminal database, i.e. terminalDatabase.supportsDeviceClass(dc)==true, the device detector application is called, given this class as an argument.
5. The device detecting arrangement presents the user with a device configuration page. This is possible, because if the device class is known, it is possible to generate a page in the markup language understandable by the end user station (the device).
6. The user configures his device (end user station) and saves the data. The saved data is then forwarded to, and stored into the terminal database.
7. The user can now enter the portal.

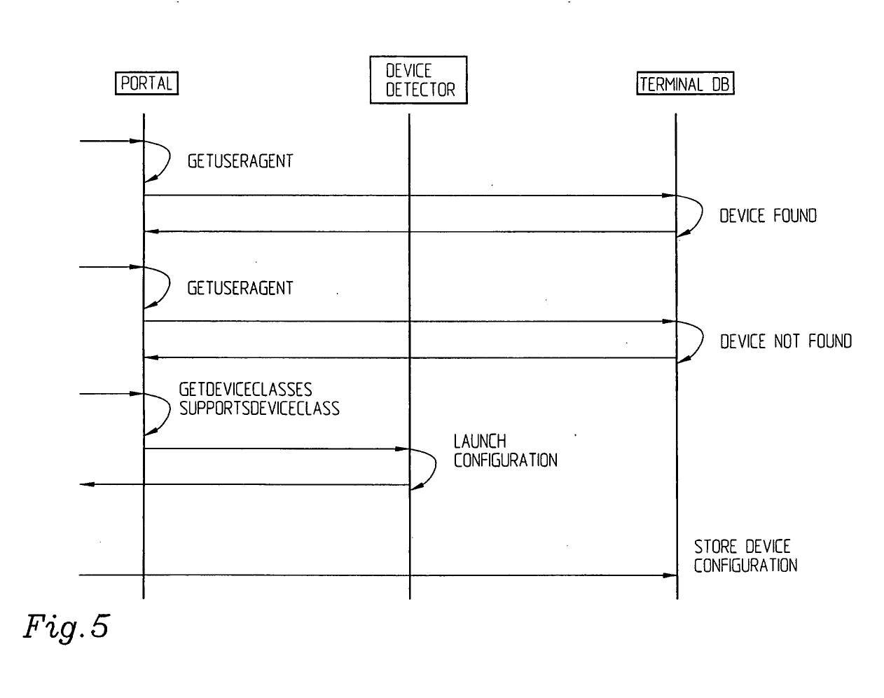

The interactions between the portal, i.e. the request broker, the device detecting arrangement and the terminal database, are also illustrated in the interaction diagram of FIG. 5.

httpRequest.getAgent( ), httpRequest.getDeviceClasses( ) as referred to above, can be implemented using the information supplied by the HTTP protocol.

terminalDatabase.supportsDeviceClass(DeviceClass dc) can be implemented using the previous operations and any database.

It should be clear that the invention is not limited to the use of HTTP as an access protocol, but the inventive concept can be implemented for any access protocol providing information about end user station class belonging(s) and end user station type. It is also a requirement that some kind of storing means is provided supporting storing of end user station basic information (class/group information) and type information. Also in other respects the invention is not limited to the specifically illustrated embodiments, but it can be varied in a number of ways within the scope of the appended claims.

1. A portal node providing access to end user stations using an access protocol for communicating an access request wherein said access request contains station information about a particular end user station, which station information includes class information specifying a particular class to which said a requesting end user station belongs and type information specifying the type of the requesting end user station, comprising:
a portal session managing means for managing a communication session with an end user station;
a request handling means for processing an access request from a particular end user station;
a portal storing means for storing station information for some of said end user stations;
a device detection arrangement; wherein
in response to said request handling means determining that type information associated with a requesting end user station is not stored within said portal storing means, said request handling means retrieving pre-stored information associated with said class information associated with said requesting end user station and said device detection arrangement using said retrieved pre-stored information to request type information from said requesting end user station and storing said type information received from the end user station with said portal storing means.

2. The portal node according to claim 1, wherein the access protocol is HTTP.

3. The portal node according to claim 1, wherein said access protocol is based on a generic markup language supporting access by end user stations independently of type or class of end user station.

4. The portal node according to claim 3, wherein the generic markup language is XML.

5. The portal node according to claim 3 4, further comprising rendering means for translating service data from an accessed service using a generic markup language into the markup language used by the accessing end user station.

6. The portal node according to claim 1, wherein the class information for a particular end user station comprises information relating to the markup language used and understandable by the end user station.

7. The portal node according to claim 1, wherein the type information comprises a type indicator comprising a user agent for uniquely identifying the end user station or the browser used by the end user station.

8. (canceled)

9. The portal node according to claim 7, wherein if the type indicator in an end user access request is recognized by the portal, the corresponding type information is stored in the portal storing means, and the corresponding type information is fetched by the request handling means for storing the information about the end user in a portal session created by the portal session managing means.

10. The portal node according to claim 1, wherein if the type indication information in an end user access request is not recognized, it is examined if the group information for a group indicated by the request message is available in the portal storing means, and that information about a recognized group is passed on to the device detecting arrangement and in that the device detecting arrangement presents a configuration page to the end user station requesting type information for the end user station.

11. The portal node according to claim 10, wherein the end user type information is retrieved by the device detection arrangement for storing into the portal storing means.

12. The portal node according to claim 10, wherein the group information comprises information about the markup language used by the end user station, allowing the device detection arrangement to communicate with requesting end user stations, for which the type is not recognized.

13.-16. (canceled)

17. A method of providing an end user station with access to a portal structure, when said end user station requests access to the portal structure, by means of a request, which contains information relating to the type of end user station and basic information relating to group belongings of the end user station, comprising the steps of:
receiving the end user station request in the portal structure,
examining if the end user station type is recognized by the portal; if yes, providing the end user station with access to the portal; if not,
examining if there is any information about the group to which the end user station belongs; if yes,
using the recognized group information to retrieve further information relating to the type of the end user station from the end user station;
storing the retrieved type information in the portal storing means; and
allowing the end user station to access the portal.

18. The method of claim 17, wherein HTTP protocol is used as an access protocol for the end user station access request.

19. The method of claim 17, wherein the group information comprises information about the markup language* used and supported by the end user station.

20. The method of claim 19, wherein the step of examining if the type of the end user station is known to the portal comprises:
examining if the type is stored in the portal storing means, and in that the step of examining if any of the group is known to the portal comprises:
examining if any of the group is stored in the portal storing means.

21. The method of class 19, wherein the step of retrieving further information from the end user station comprises:
fetching the group information comprising markup language information from the portal storing means to a device detecting arrangement;
using the markup language in the detecting arrangement according to the group information to present a configuration page to the end user station;
retrieving requested configuration data from the end user station to the device detecting arrangement;
storing the received configuration data into the portal storing means; and
allowing the end user station to access the portal.

22. A portal node for providing access to an end user station, wherein said end user station request access to said portal node using an access request which contains information relating to the station type associated with a requesting end user station and basic information relating to a particular group associated with said requesting end user station, comprising:
means for receiving an access request from a particular end user station;
means for determining if the station type associated with said end user station is stored within said portal node;
if yes, providing access to said end user station;
if not, means for determing if any group information for said group associated with said end user station is stored within said portal node; and
if yes, means for retrieving station type from said end user station using the stored group information; and
means for storing said retrieved station type from sand end user station and allowing access to said end user station.

23. The portal node of claim 22, wherein HTTP protocol is used as an access protocol for the end user station access request.

24. The portal node of claim 22, wherein the group information comprises information about the markup language used and supported by the end user station.

25. The portal node of claim 24, wherein said means for retrieving said station type from the end user station further comprises:
a portal storage means;
device detection arrangement; and
means for fetching the group information including markup language information from said portal storage means and providing it to said device detection arrangement;
wherein said device detection arrangement presents a configuration page to said end user station using said fetched group information requesting said station type, retrieves said requested station type from said end user station and storing said station type with said portal storage means.
